(19) United States
(12) Patent Application Publication
(10) Pub. No.: US 2022/0360878 A1
(43) Pub. Date: Nov. 10, 2022

(54) Earphone Holding Member and Earphone

(71) Applicant: Yamaha Corporation, Hamamatsu-shi (JP)

(72) Inventors: Yasuaki TAKANO, Kikugawa-shi (JP); Kunihiro TAKEI, Hamamatsu-shi (JP)

(21) Appl. No.: 17/739,889

(22) Filed: May 9, 2022

(30) Foreign Application Priority Data
May 10, 2021 (JP) 2021-079497

(51) Int. Cl. H04R 1/10

(52) U.S. Cl. CPC H04R 1/105; H04R 1/1041; H04R 1/1016; H04R 2420/07

(57) ABSTRACT

An earphone holding member includes a holder. The holder includes a side portion and a plane portion. The side portion is configured to contact at least a lower antihelix crus, an antihelix, and an antitragus of an ear. The plane portion configured to partially and planarly contact the ear.

### CROSS REFERENCE TO RELATED APPLICATIONS

This application claims priority under 35 U.S.C. § 119(a) on Patent Application No. 2021-079497 filed in Japan on May 10, 2021, the entire contents of which are hereby incorporated by reference.

### BACKGROUND

An embodiment of the present disclosure relates to an earphone holding member used by being inserted into an ear canal of a wearer.

U.S. Pat. No. 10,149,038 discloses an earphone configured such that a flexible ring-shaped protrusion comes into contact with a lower antihelix crus to make it difficult to fall out of an ear.

U.S. Pat. No. 9,980,031 discloses an earphone including a fin that comes into contact with a lower antihelix crus and an antihelix.

In a case of sports or other situations in which intense movement occurs, additional holding force is desired.

### SUMMARY

In view of the foregoing, an embodiment of the present disclosure is directed to provide an earphone holding member having higher holding force than before.

An earphone holding member includes a holder including a side portion to contact at least a lower antihelix crus, an antihelix, and an antitragus of an ear of a wearer and a plane portion to partially and planarly contact the ear.

According to an embodiment of the present disclosure, an earphone holding member having higher holding force than before is able to be obtained.

### BRIEF DESCRIPTION OF THE DRAWINGS

FIG. 1 is a view showing a state in which an earphone 1 is worn in an ear;

FIG. 2A is a front view of the earphone 1;

FIG. 2B is a rear view of the earphone 1;

FIG. 3A is a right side view of the earphone 1;

FIG. 3B is a left side view of the earphone 1;

FIG. 4A is a top view of the earphone 1;

FIG. 4B is a bottom view of the earphone 1;

FIG. 5 is a right side view of a holding member 20 removed from a main body;

FIG. 6 is a view showing a state in which the holding member 20 is in contact with an ear;

FIG. 7A is a right side view of a large sized holding member 20;

FIG. 7B is a right side view of a small sized holding member 20; and

FIG. 8 is a rear view of an earphone 1 as another example.

### DETAILED DESCRIPTION

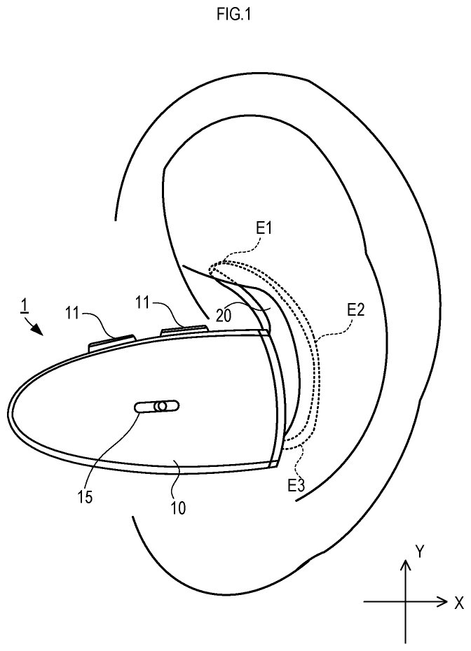

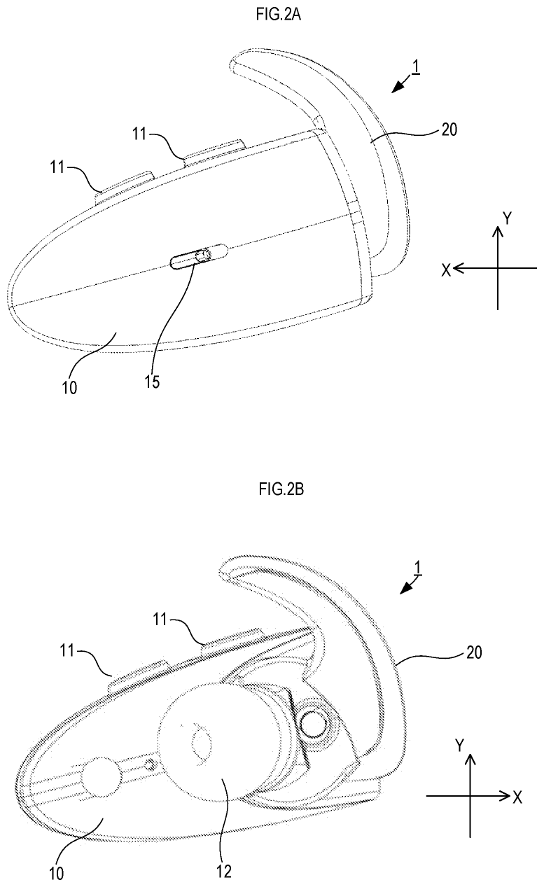

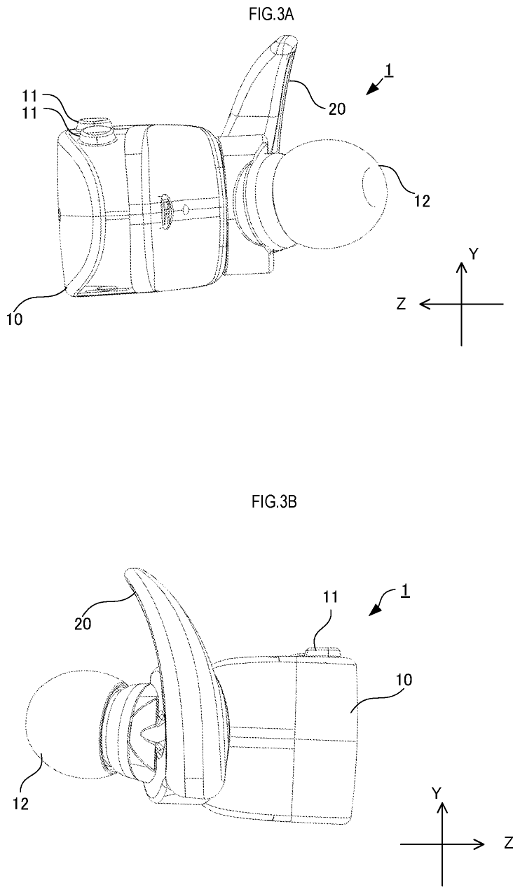

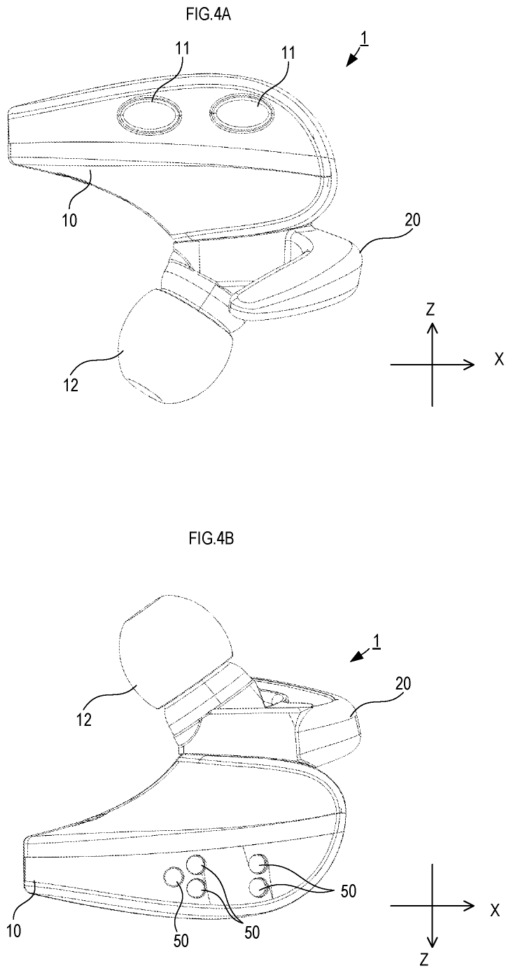

FIG. 1 is a view showing a state in which an earphone is worn in an ear 1. FIG. 2A is a front view of the earphone 1. FIG. 2B is a rear view of the earphone 1. FIG. 3A is a right side view of the earphone 1. FIG. 3B is a left side view of the earphone 1. FIG. 4A is a top view of the earphone 1. FIG. 4B is a bottom view of the earphone 1. It is to be noted that, in the drawings, a front direction, a top direction, and a left side direction are respectively referred to as an X direction, a Y direction, and a Z direction.

The earphone 1 receives an audio signal through wireless communication such as Bluetooth (registered trademark), from an information processing terminal such as a smartphone, or a player such as a portable music reproduction apparatus. However, the present disclosure is not limited to an earphone for wireless communication. The earphone may be connected to the player with a cable.

The earphone 1 includes two units of a unit used by being inserted into a left ear and a unit used by being inserted into a right ear. The right and left units are not connected with a cable or the like. In other words, the earphone 1 is a true wireless earphone including right and left independent units. However, the present disclosure does not need to be right and left independent units. The right and left independent units may be connected with a cable.

It is to be noted that, while the present embodiment describes a unit used by being inserted into a left ear, a unit used by being inserted into a right ear also has the same configuration and function.

The earphone 1 includes a main body 10, a button 11, an insert portion 12, a hole 15, and a holding member 20.

The earphone 1 is used by being inserted into an ear canal. The main body 10 includes a driver unit, a battery, a microphone, and similar components. A length (a thickness) in the left side direction of the main body 10 is small, and a length (a height) in the Y direction and a length (a depth) in the X direction are larger than the thickness.

In addition, the depth of the main body 10 is larger than the height. The rear side of the main body 10 is almost linear, when viewed from a right side. The front side of the main body 10 is gradually reduced in height in the front direction, and a tip of the front side is narrowed into an arc-like shape. The left side of the main body 10 is almost planar and is inclined to the right side in the rear direction. The hole 15 is provided at almost the center position of a left side surface of the main body 10. The hole 15 acoustically opens a sound collecting surface of the microphone that is built into the main body 10.

It is to be noted that a shape of the main body 10 shown in the present embodiment is an example, and the shape of the main body of the present disclosure is not limited to the example shown in the present embodiment.

The button 11 is disposed on an upper side of the main body 10. The button 11 may include a volume UP button and a volume DOWN button, for example. A charging terminal 50 to charge a battery is provided on a lower side of the main body 10.

The insert portion 12 is disposed on the right side of the main body 10. A right side surface of the main body 10 expands into a cylindrical shape in a portion into which the driver unit is built. The insert portion 12 is disposed so as to protrude from the portion that expands into a cylindrical shape in the right side direction.

The insert portion 12 is inserted into the ear canal of a wearer. The insert portion 12 is covered by an earpiece. The earpiece may be made of a resin with high flexibility, such as silicone rubber, polyurethane, or epoxy, for example. The earpiece may be integrated with the insert portion 12 or may be attachable to and detachable from the insert portion 12. In a case in which the earpiece is attachable to and detachable from the insert portion 12, a plurality of types of earpieces of different sizes may be prepared. In such a case, the wearer can select an earpiece of a suitable size according to the size of the ear.

The holding member 20 is disposed between the main body 10 and the insert portion 12. The holding member 20 is attached to the main body 10 through a cylindrically expanded portion of the main body 10, the part including the built-in driver unit.

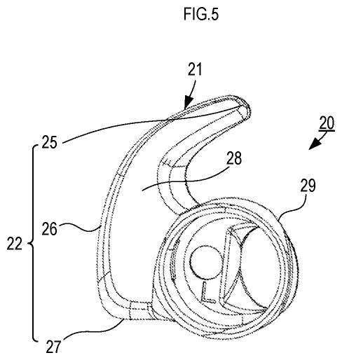

FIG. 5 is a right side view showing a shape of the holding member 20 removed from the main body 10. The holding member 20 includes a holder 21 and a cover 29. The holder 21 includes a side portion 22 made of a lower antihelix crus contactor 25, an antihelix contactor 26, and an antitragus contactor 27, and a plane portion 28.

The cover 29 is shaped so as to cover the cylindrically expanded portion in the main body 10. The cover 29 includes a small opening to insert the insert portion 12, and a large opening to cover the cylindrically expanded portion in the main body 10. The cover 29 may be made of a material with high flexibility, such as silicone rubber, polyurethane, or epoxy, for example. The cover 29 is configured to be attachable to and detachable from the main body 10 so as to be put around the cylindrically expanded portion from the large opening through the insert portion 12.

The holder 21 is provided on the rear side of the cover 29. The holder 21 has an L shape that, when viewed from the side, extends from the cover 29 to the rear side and extends to a top side. The holder 21 is integrally formed with the cover 29.

The bottom surface of the holder 21 configures the antitragus contactor 27 with a straight shape when viewed from the side. The rear side of the holder 21 almost vertically rises in the top direction with respect to the antitragus contactor 27, and configures the antihelix contactor 26 with a curved shape that gradually curves in the front direction. The antihelix contactor 26 curves more in the front direction as toward the top side, and a tip of the top side is inclined at about 45 degrees in the front direction. Therefore, the top side of the holder 21 is diagonally inclined at about 45 degrees in the front direction. The top side of the holder 21 configures the lower antihelix crus contactor 25.

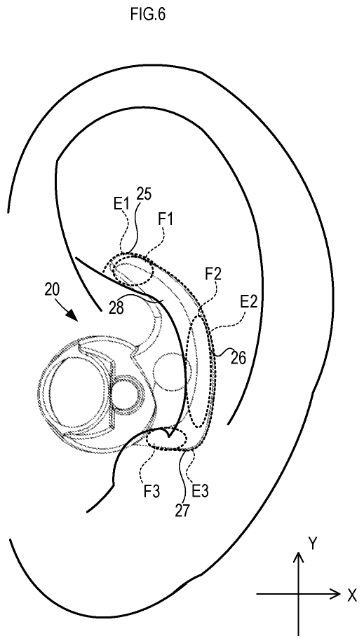

FIG. 6 is a view showing a state in which the holding member 20 is in contact with an ear. As shown in FIG. 6, the holding member 20 is fitted into a concha. The lower antihelix crus contactor 25 of the side portion 22 of the holder 21 contacts a lower antihelix crus E1. The antihelix contactor 26 contacts an antihelix E2. The antitragus contactor 27 contacts an antitragus E3.

In addition, the plane portion 28 planarly contacts an ear. As shown in FIG. 6, the plane portion 28 contacts a first portion F1 near the lower antihelix crus contactor 25, a second portion F2 near the antihelix contactor 26, and a third portion F3 near the antitragus contactor 27.

In a case in which the holding member 20 is worn in the ear of a wearer, the main body 10 of the earphone 1 to which the holding member 20 is attached protrudes more outward than the ear of a wearer.

As described above, the holding member 20 of the present embodiment includes the holder 21 including the side portion 22 to contact at least the lower antihelix crus E1, the antihelix E2, and the antitragus E3 of the ear of a wearer and a plane portion 28 to partially and planarly contact the ear.

The side portion 22, since contacting inside of the concha at three points of the lower antihelix crus contactor 25, the antihelix contactor 26, and the antitragus contact portion 27, is able to achieve very high adhesion. In addition, since the lower antihelix crus contactor 25 and the antitragus contactor 27 face each other, opposite force is applied to both contactors.

Moreover, the plane portion 28 planarly contacts the ear inside the concha. The plane portion 28, since planarly contacting the inside of the concha, is able to significantly reduce a position of the earphone 1 from shifting due to frictional force. Further, the plane portion 28, in a case in which force in a direction in which the earphone 1 is removed is applied, planarly contacts the inside of the concha, and produces reaction force in a direction opposite to the direction in which the earphone 1 is removed. Therefore, the holding member 20 is able to achieve very high adhesion.

As described above, the holding member 20 of the present embodiment, even in a case of sports or other situations in which intense movement occurs, is able to achieve high holding force to significantly reducing the earphone 1 from shifting at a position and coming off from the ear.

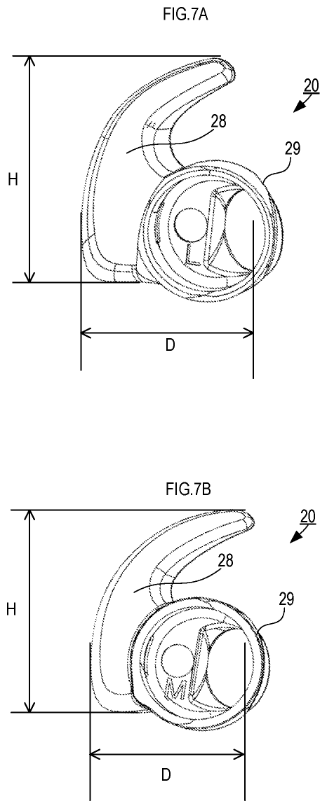

It is to be noted that the main body 10 is configured to be attachable to and detachable from any of a plurality of types of holding members of different sizes. FIG. 7A is a right side view of a relatively large sized holding member 20, and FIG. 7B is a right side view of a relatively small sized holding member 20.

A height H of the holding member 20 corresponding to a length from the lower antihelix crus to the antitragus is increased as a depth D of the holding member 20 corresponding to a length from the antihelix to the ear canal is increased. In addition, an amount by which the height H of the holding member 20 is increased is larger than an amount by which the depth D is increased. For example, the height H of the relatively large sized holding member 20 shown in FIG. 7A is 23.5 mm, and the depth D is 20.5 mm. The height H of the relatively small sized holding member 20 shown in FIG. 7B is 23.0 mm, and the depth D is 19.0 mm.

A shape of the concha varies depending on the size of the ear of a wearer. Variation in ear size is greater in length from the lower antihelix crus to the antitragus than in length from the antihelix to the ear canal. The amount by which the height H of the holding member 20 is increased is larger than the amount by which the depth D of the holding member 20 is increased, so that both a wearer with a large ear and a wearer with a small ear can properly contact the holding member 20 with the concha. Accordingly, the holding member 20 according to the present embodiment is able to provide very high adhesion for both a wearer with a large ear and a wearer with a small ear.

As described above, the earphone 1 according to the present embodiment, by being configured such that a plurality of holding members having different heights and depths are attachable and detachable, is able to achieve proper adhesion according to the size of an ear.

The description of the foregoing embodiments is illustrative in all points and should not be construed to limit the present disclosure. The scope of the present disclosure is defined not by the foregoing embodiments but by the following claims for patent. Further, the scope of the present disclosure is intended to include all modifications within the scopes of the claims for patent and within the meanings and scopes of equivalents.

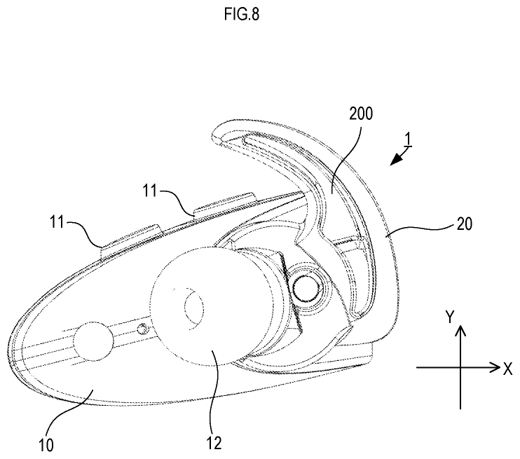

For example, the inside of the holder 21 may be hollow. The holder 21 being hollow becomes a lighter component and is able to reduce a load on a wearer. In addition, the holding member 20, even in the case in which the holder 21 is hollow, includes the side portion 22 to contact at least the lower antihelix crus E1, the antihelix E2, and the antitragus E3 of the ear of a wearer and the plane portion 28 to partially and planarly contact the ear, so that the holding force is not reduced. Moreover, as shown in FIG. 8, the holder 21 may partially include a cutout 200. In such a case as well, the holder 21 becomes a lighter component and is able to reduce a load on a wearer. In addition, the holding member 20, even in a case of partially including the cutout 200, includes the side portion 22 to contact at least the lower antihelix crus E1, the antihelix E2, and the antitragus E3 of the ear of a wearer and the plane portion 28 to partially and planarly contact the ear, so that the holding force is not reduced.

What is claimed is:

1. An earphone holding member comprising:
a holder including:
a side portion configured to contact at least a lower antihelix crus, an antihelix, and an antitragus of an ear; and
a plane portion configured to partially and planarly contact the ear.

2. The earphone holding member according to claim 1, wherein an opposite force is applied to a portion configured to contact the lower antihelix crus and a portion configured to contact the antitragus.

3. The earphone holding member according to claim 1, wherein an inside of the holder is hollow.

4. The earphone holding member according to claim 1, wherein the holder is configured to be attachable to and detachable from a main body of an earphone.

5. The earphone holding member according to claim 4, wherein:
a height of the holder, corresponding to a length from the lower antihelix crus to the antitragus, increases as a depth of the holder, corresponding to a length from the antihelix to an ear canal, increases; and
an amount by which the height increases is larger than an amount by which the depth increases.

6. The earphone holding member according to claim 1, wherein, in a case in which the holding member is worn in the ear, a main body of an earphone to which the holding member is attached protrudes outwardly more than the ear.

7. An earphone comprising:
a main body;
an insert portion that is insertable into an ear canal; and
a holding member including a holder including:
a side portion configured to contact at least a lower antihelix crus, an antihelix, and an antitragus of an ear; and
a plane portion configured to partially and planarly contact the ear.

8. The earphone according to claim 7, wherein an opposite force is applied to a portion configured to contact the lower antihelix crus and a portion configured to contact the antitragus.

9. The earphone according to claim 7, wherein an inside of the holder is hollow.

10. The earphone according to claim 7, wherein the holder is configured to be attachable to and detachable from the main body.

11. The earphone according to claim 10, wherein:
the main body is configured such that any of a plurality of types of holding members having a different height, corresponding to a length from the lower antihelix crus to the antitragus, and a different depth, corresponding to a length from the antihelix to an ear canal, is attachable and detachable;
a height of the plurality of types of holding members increases as a depth of the plurality of types of holding members increases; and
an amount by which the height increases is larger than an amount by which the depth increases.

12. The earphone according to claim 7, wherein, in a case in which the holding member is worn in the ear, the main body protrudes outwardly more than the ear.

13. The earphone according to claim 7, wherein an audio signal is received through wireless communication.

14. The earphone according to claim 13, further comprising: an independent left unit and right unit that are insertable, respectively, into a left ear and right ear.
